(19) United States
(12) Patent Application Publication
(10) Pub. No.: US 2024/0291035 A1
(43) Pub. Date: Aug. 29, 2024

(54) ELECTROLYTE FOR LITHIUM-SULFUR BATTERY AND LITHIUM-SULFUR BATTERY INCLUDING SAME

(71) Applicant: IUCF-HYU (INDUSTRY-UNIVERSITY COOPERATION FOUNDATION HANYANG UNIVERSITY), Seoul (KR)

(72) Inventors: Dong-Won KIM, Seoul (KR); Da-Ae LIM, Seoul (KR); Jun-Hwan AHN, Seoul (KR); Tae-Sun YOU, Anyang-si, Gyeonggi-do (KR); Ji-Wan KIM, Seoul (KR)

(21) Appl. No.: 18/570,071

(22) PCT Filed: Jun. 2, 2022
(86) PCT No.: PCT/KR2022/007829

§ 371 Date: Dec. 14, 2023

(30) Foreign Application Priority Data
Jun. 15, 2021 (KR) 10-2021-0077264
Sep. 13, 2021 (KR) 10-2021-0121498

(51) Int. Cl. H01M 10/0567; H01M 4/36; H01M 4/38; H01M 4/58; H01M 4/62; H01M 10/052; H01M 10/0565; H01M 10/0568; H01M 10/0569

(52) U.S. Cl. CPC H01M 10/0567; H01M 4/366; H01M 4/382; H01M 4/5815; H01M 4/628; H01M 10/052; H01M 10/0565; H01M 10/0568; H01M 10/0569; H01M 2300/0037; H01M 2300/0082

(57) ABSTRACT

The present disclosure relates to an electrolyte for a lithium-sulfur battery comprising: a base electrolyte comprising a lithium salt and an organic solvent; and an electrolyte additive, wherein the electrolyte additive comprises an isocyanate functional group (—N═C═O).

### TECHNICAL FIELD

The present disclosure relates to an electrolyte for a lithium-sulfur battery and a lithium-sulfur battery including the same, and more specifically, to an electrolyte for a lithium-sulfur battery with improved electrochemical performance and cycle characteristics of secondary batteries by suppressing the elution of lithium polysulfide generated in the battery by using a novel electrolyte additive and a lithium-sulfur battery including the same.

### BACKGROUND ART

With the development of portable mobile electronic devices, such as a smart phone, an MP3 player, and a tablet PC, the demand for secondary batteries capable of storing electric energy is explosively increasing. Particularly, with the advent of electric vehicles, medium and large energy storing systems, and portable devices requiring high energy density, the demand for secondary batteries is increasing.

The lithium secondary batteries are a type of secondary batteries that may be charged with energy using an external power source and have many benefits such as high energy density and long lifespan characteristic. As the scope of utilization of lithium secondary batteries expands not only to portable electronic devices and communication devices, but also to electric vehicles and power storage devices, there is an increasing demand for higher capacity and lower prices of lithium secondary batteries used as power sources.

A lithium-sulfur (Li—S) battery is a secondary battery that uses a sulfur-based material with an S—S bond as a cathode active material and lithium metal as an anode active material. Sulfur is non-toxic, abundant in raw materials, and cheap, so unit costs of production may be lowered. In addition, the theoretical discharge capacity of the lithium-sulfur battery is 1675 mAh/g and the theoretical energy density is 2600 Wh/kg, which are very high compared to the theoretical energy density of other secondary battery systems, thereby attracting a lot of attention in terms of high energy density.

Although the lithium-sulfur battery has a low unit cost and high energy density, the systems such as a anode, a cathode, and an electrolyte constituting the secondary battery have not yet been stably implemented, and side reactions occur, resulting in electrochemical performance lower than the theoretical energy density.

Accordingly, various studies are being conducted to improve the structure and materials of lithium-sulfur batteries, prevent side reactions, and improve electrochemical performance and lifespan characteristics.

### RELATED ART DOCUMENT

Korean Patent No. 10-0467456 (Jan. 12, 2005)

### DISCLOSURE

### Technical Problem

One technical task of the present disclosure is directed to providing a novel electrolyte for a lithium-sulfur battery and a lithium-sulfur battery including the same.

Another technical task of the present disclosure is directed to providing an electrolyte for a lithium-sulfur battery with excellent electrochemical characteristics and cycle characteristics by suppressing the elution of lithium polysulfide and a lithium-sulfur battery including the same. The technical tasks of the present disclosure are not limited to the aforementioned ones.

### Solution to Problem

In order to solve the above technical problems, the present invention provides an electrolyte for a lithium-sulfur battery, and a lithium-sulfur battery including the same.

In one embodiment, the electrolyte for a lithium-sulfur battery comprising: a base electrolyte comprising a lithium salt and an organic solvent; and an electrolyte additive, wherein the electrolyte additive comprises an isocyanate functional group (—N═C═O).

In one embodiment, the electrolyte additive may be one or more of hexamethylene diisocyanate, isophorone diisocyanate, methylene diisocyanate, toluene diisocyanate, 4,4-diisocyanato dicyclohexylmethane, 1,5-naphthalene diisocyanate, tetramethyl xylene diisocyanate, para-phenylene diisocyanate, 1,4-cyclohexane diisocyanate, 1,8-diisocyanatooctane, or 2,4,4-trimethylhexamethylene diisocyanate.

In one embodiment, the lithium salt may be at least one of LiPF₆, LiBF₄, LiClO₄, LiSbF₆, LiAsF₆, Li(NO₃)₃, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂)(C_{y}F_{2y+1}SO₂), where x and y are natural numbers, LiCl, LiI, or LiB(C₂O₄)₂.

In one embodiment, the lithium salt may be included at a molar concentration of 0.1 M to 5 M.

In one embodiment, the organic solvent may be a non-aqueous organic solvent; and the non-aqueous organic solvent may be at least one of an ether-based material, 1,2-dimethoxyethane, 1,3-dioxolane, or dimethyl sulfoxide.

In one embodiment, the ether-based material may be at least one of diethylene glycol dimethyl ether, triethylene glycol dimethyl ether, or tetraethylene glycol dimethyl ether.

In one embodiment, the electrolyte additive may be included in an amount of 1 to 5 parts by weight based on 100 parts by weight of the electrolyte for the lithium-sulfur battery.

A second aspect of the present disclosure provides the lithium-sulfur battery comprising: the electrolyte for the lithium-sulfur battery according to any one of claims 1 to 7; a cathode comprising a sulfur compound; an anode comprising lithium; and a separator interposed between the cathode and the anode.

In one embodiment, at least one of the cathode or the separator further comprises a polymer layer represented by Formula 1 below:

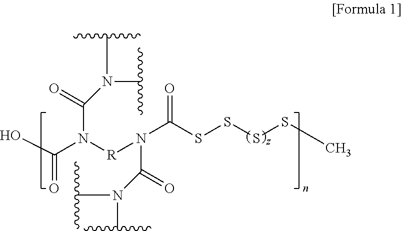

wherein, R is a substituted or unsubstituted C1 to C30 alkyl group or a substituted or unsubstituted C1 to C30 haloalkyl group, n is an integer from 1 to 100, and z is an integer from 1 to 5.

In one embodiment, the Formula 1 may be formed by reacting lithium polysulfide with an electrolyte additive; and the electrolyte additive comprises an isocyanate functional group (—N═C═O).

In one embodiment, the electrolyte additive may be one or more of hexamethylene diisocyanate, isophorone diisocyanate, methylene diisocyanate, toluene diisocyanate, 4,4-diisocyanato dicyclohexylmethane, 1,5-naphthalene diisocyanate, tetramethyl xylene diisocyanate, para-phenylene diisocyanate, 1,4-cyclohexane diisocyanate, 1,8-diisocyanatooctane, or 2,4,4-trimethylhexamethylene diisocyanate.

In one embodiment, the electrolyte additive may be one or more of hexamethylene diisocyanate, 1,8-diisocyanatooctane, or 2,4,4-trimethylhexamethylene diisocyanate; and the electrolyte additive reacts with lithium polysulfide to produce one or more of Formulas 2, 3, or 4 below, and is provided in at least one of the cathode or the separator:

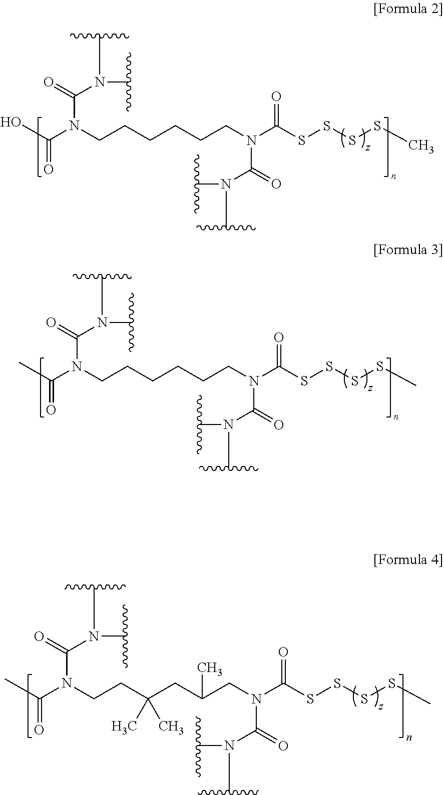

wherein, n is an integer from 1 to 100, and z is an integer from 1 to 5.

### Advantageous Effects

According to an embodiment of the present disclosure, by including a small amount of an additive including a highly reactive isocyanate functional group as an additive in a liquid electrolyte, an ion-conductive polymer layer is formed through a chemical reaction with lithium polysulfide, thereby suppressing the elution of lithium polysulfide generated from a cathode.

In addition, according to an embodiment of the present disclosure, the lithium-sulfur battery to which a novel electrolyte is applied suppresses the decline in the capacity of the cathode due to lithium polysulfide elution, thereby enabling the implementation of a high-capacity battery. Furthermore, the lithium-sulfur battery with improved battery lifespan characteristics while maintaining low manufacturing costs can be provided.

### BRIEF DESCRIPTION OF DRAWINGS

FIG. 1 is a diagram schematically illustrating the mechanism by which lithium polysulfide produced at a cathode reacts with an electrolyte additive including an isocyanate group.

FIGS. 2A and 2B show the results of identifying the reactivity with lithium polysulfide according to the type of precursor solution according to Experimental Examples 1-1 to 1-7.

FIG. 3A, 3B, 3C and 3D are a reaction device for identifying suppression of lithium polysulfide elution.

FIG. 4A, 4B and 4C show the results of identifying the extent to which the elution of lithium polysulfide is suppressed by hexamethylene diisocyanate.

FIGS. 5A and 5B are a diagram illustrating (a) a polyethylene separator and (b) the product of Experimental Example 2-2 formed on the polyethylene separator (b).

FIG. 6 shows the results of identifying the extent to which the elution of lithium polysulfide is suppressed by 1,8-diisocyanatooctane and 2,4,4-trimethylhexamethylene diisocyanate.

FIG. 7 shows the results identified according to the linear-sweep voltammetry in the case of liquid electrolyte and in the case of adding hexamethylene diisocyanate to the liquid electrolyte.

FIG. 8A, 8B and 8C are a graph showing charge and discharge cycles according to hexamethylene diisocyanate content.

FIG. 9A, 9B and 9C show the results of identifying charge/discharge curves and lifespan characteristics depending on whether 3 wt % of hexamethylene diisocyanate is included in the electrolyte.

FIGS. 10A and 10B show the results of impedance interfacial resistance analysis (a) before cycling and (b) after 200 cycles depending on whether 3 wt % of hexamethylene diisocyanate is included in the electrolyte.

FIG. 11A, 11B and 11C are an SEM photograph of the cathode surface before cycling and after 200 cycles.

### DESCRIPTION OF EMBODIMENTS

Hereinafter, the preferable embodiments of the present disclosure will be described with reference to the accompanying drawings. However, the technical spirit of the present disclosure is not limited to the exemplary embodiments described herein, but may also be implemented in other forms. Rather, the embodiments introduced herein are provided so as to make the disclosed contents be thorough and complete and to fully transfer the spirit of the present disclosure to those skilled in the art.

In the present specification, when it is said that one constituent is formed on another constituent element, the constituent may be directly formed on another constituent, or may be formed on the another constituent with a third constituent element interposed therebetween. Further, in the drawings, thicknesses of layers and regions are exaggerated for the effective description of the technical contents.

Further, in the various exemplary embodiments of the present specification, although terms, such as “a first”, “a second”, and “a third”, are used for describing various constituents, but the constituents are not limited by the terms. The terms are simply used for discriminating one constituent from another constituent. Accordingly, a first constituent mentioned in any one exemplary embodiment may also be mentioned as a second constituent in another exemplary embodiment. Each exemplary embodiment described and exemplified herein also includes a complementary exemplary embodiment thereof. Further, in the present specification, the term “and/or” is used as a meaning including at least one among the constituents listed before and after.

Singular expressions used herein include plurals expressions unless the context clearly dictates otherwise. It will be appreciated that terms “including” and “having” are intended to designate the existence of characteristics, numbers, steps, constituent elements, and a combination thereof described in the specification, and do not exclude a possibility of the existence or addition of one or more other characteristics, numbers, steps, constituents, or a combination thereof.

Further, in the following description of the present disclosure, when a detailed description of a related publicly known function or configuration is determined to unnecessarily make the subject matter of the present disclosure unclear, the detailed description thereof will be omitted.

An embodiment of the present disclosure relates to an electrolyte for a lithium-sulfur battery including: a base electrolyte including a lithium salt and an organic solvent; and an electrolyte additive, wherein the electrolyte additive includes an isocyanate functional group (—N═C═O). For example, the electrolyte additive may include one or more of hexamethylene diisocyanate, isophorone diisocyanate, methylene diisocyanate, toluene diisocyanate, 4,4-diisocyanato dicyclohexylmethane, 1,5-naphthalene diisocyanate, tetramethyl xylene diisocyanate, para-phenylene diisocyanate, 1,4-cyclohexane diisocyanate, 1,8-diisocyanatooctane, or 2,4,4-trimethylhexamethylene diisocyanate.

Typically, during the discharge process of a lithium-sulfur battery, an oxidation reaction of lithium occurs at an anode and a reduction reaction of sulfur occurs at a cathode. Sulfur has an annular structure of S₈, and the oxidation number of S decreases as a S—S bond is broken in the process of a reduction reaction during discharge. In addition, the oxidation number of S increases as the S—S bond is formed again in the process of an oxidation reaction during charge, and electrical energy is stored and produced in a lithium-sulfur battery through this oxidation-reduction reaction of sulfur. The sulfur is converted from S₈ of the annular structure to lithium polysulfide (Li₂Sₓ, x=2, 4, 6, 8), which has a linear structure, through a reduction reaction, and finally lithium sulfide (Li₂S) is produced. The lithium polysulfide may be provided in various oxidation numbers. Among them, lithium polysulfide (x>4), which has a high oxidation number of sulfur, is easily eluted in an electrolyte. The lithium polysulfide eluted in the electrolyte diffuses toward a lithium anode due to the difference in concentration and is no longer able to participate in oxidation and reduction reactions at a cathode, which is a major cause of reduced capacity and lifespan of lithium-sulfur batteries. In addition, some lithium polysulfides react directly with the lithium of the anode and are reduced to Li₂S on the surface of the lithium, causing an issue of corrosion of a lithium metal anode.

The lithium-sulfur battery according to this embodiment may further include a liquid electrolyte additive in the electrolyte. The electrolyte additive is provided in a liquid form and may be uniformly mixed in a base electrolyte, which is mostly composed of an organic solvent. In addition, the electrolyte additive selectively reacts with lithium polysulfide eluted from the cathode of the lithium-sulfur battery to form a polymer layer at the electrolyte interface of the cathode or the electrolyte interface of a separator. The polymer layer has high ionic conductivity and may act as a membrane that prevents lithium polysulfide from eluting and spreading into the electrolyte. Accordingly, since lithium polysulfide is not lost in the electrolyte, it remains in the cathode and participates in charging and discharging, thereby preventing the capacity and lifespan characteristics of the lithium-sulfur battery from being deteriorated.

The electrolyte additive may include an isocyanate functional group (—N═C═O), and the isocyanate functional group may react with lithium polysulfide to form a polymer membrane. Specifically, the carbon (C) of the isocyanate functional group is provided with each of nitrogen (N) and oxygen (O) with relatively high electronegativity on both sides, and due to the nitrogen and oxygen, the electron pairs of carbon (C) are leaned towards the nitrogen and oxygen. In this connection, polysulfide anions and radicals attack the partially protonated carbon of the isocyanate functional group to initiate a polymerization reaction, and polymerization progresses through continuous chain growth to form a polymer membrane. In other words, the electrolyte additive within the electrolyte does not require a separate increase in temperature or addition of an initiator, but is provided in a predetermined concentration range within a system of the lithium-sulfur battery to react with lithium polysulfide and be prepared in the form of a polymer.

For example, the electrolyte additive may be included in an amount of 1 to 5 parts by weight based on 100 parts by weight of the electrolyte for the lithium-sulfur battery. When the content of the electrolyte additive is less than 1 part by weight, an addition amount of the electrolyte additive is too low to react with lithium polysulfide, and when the content thereof exceeds 5 parts by weight, the capacity of the lithium-sulfur battery may be deteriorated. Specifically, the electrolyte additive may be greater than 1 part by weight to less than 5 parts by weight, 2 parts by weight to less than 5 parts by weight, 2.5 parts by weight to less than 5 parts by weight, greater than 1 part by weight to 4 parts by weight, or greater than 1 part by weight to 3.5 parts by weight, or 3 parts by weight.

The lithium salt may be at least one of LiPF₆, LiBF₄, LiClO₄, LiSbF₆, LiAsF₆, Li(NO₃)₃, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂)(C_{y}F_{2y+1}SO₂), where x and y are natural numbers, LiCl, LiI, or LiB(C₂O₄)₂.

The lithium salt may be included at a molar concentration of 0.1 M to 5 M. Specifically, the lithium salt may be included in an amount of 0.2 M to 5 M, 0.3 M to 5 M, 0.5 M to 5 M, 1 M to 5 M, 2 M to 5 M, 0.5 M to 4 M, or 0.5 M to 3 M.

The organic solvent may be a non-aqueous organic solvent. For example, the non-aqueous organic solvent may be at least one of an ether-based material, 1,2-dimethoxyethane, 1,3-dioxolane, or dimethyl sulfoxide. Herein, the ether-based material may include at least one of diethylene glycol dimethyl ether, triethylene glycol dimethyl ether, or tetraethylene glycol dimethyl ether.

According to another aspect of the present disclosure, an embodiment of the present disclosure relates to a lithium-sulfur battery including: the aforementioned electrolyte for the lithium-sulfur battery; a cathode including a sulfur compound; an anode including lithium; and a separator interposed between the cathode and the anode.

At least one of the cathode or the separator may further include a polymer layer represented by Formula 1 below:

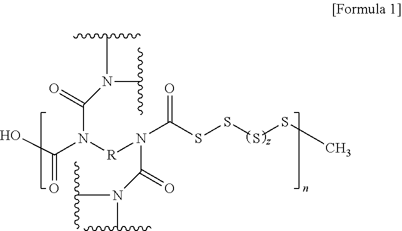

wherein, R is a substituted or unsubstituted C1 to C30 alkyl group or a substituted or unsubstituted C1 to C30 haloalkyl group, n is an integer from 1 to 100, and z is an integer from 1 to 5.

Specifically, the polymer layer represented by Formula 1 above may be provided on one surface of the cathode, and the polymer membrane provided on the one surface of the cathode may physically prevent lithium polysulfide generated from the cathode from eluted into the electrolyte. In addition, since the polymer membrane has excellent ionic conductivity, it does not impede the migration of ions in the cathode, thereby preventing the electrochemical characteristics and lifespan characteristics of the lithium-sulfur battery from being deteriorated.

Formula 1 above may be formed by reacting lithium polysulfide with an electrolyte additive, and the electrolyte additive may include an isocyanate functional group (—N═C═O).

Specifically, the electrolyte additive may include one or more of hexamethylene diisocyanate, isophorone diisocyanate, methylene diisocyanate, toluene diisocyanate, 4,4-diisocyanato dicyclohexylmethane, 1,5-naphthalene diisocyanate, tetramethyl xylene diisocyanate, para-phenylene diisocyanate, 1,4-cyclohexane diisocyanate, 1,8-diisocyanatooctane, or 2,4,4-trimethylhexamethylene diisocyanate.

More specifically, the electrolyte additive may be one or more of hexamethylene diisocyanate (HDI), 1,8-diisocyanatooctane, or 2,4,4-trimethylhexamethylene diisocyanate.

The hexamethylene diisocyanate may react with lithium polysulfide to produce Formula 2 below and may be provided in at least one of the cathode or the separator:

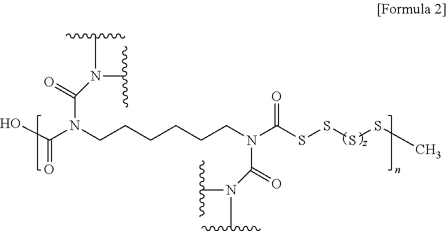

wherein, n is an integer from 1 to 100, and z is an integer from 1 to 5.

The 1,8-diisocyanatooctane may react with lithium polysulfide to produce Formula 3 below and may be provided in at least one of the cathode or the separator:

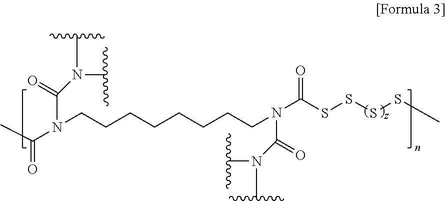

wherein, n is an integer from 1 to 100, and z is an integer from 1 to 5.

The 2,4,4-trimethylhexamethylene diisocyanate may react with lithium polysulfide to produce Formula 4 below and may be provided in at least one of the cathode or the separator:

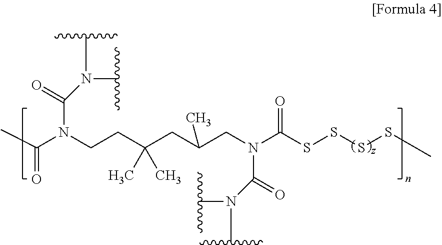

wherein, n is an integer from 1 to 100, and z is an integer from 1 to 5.

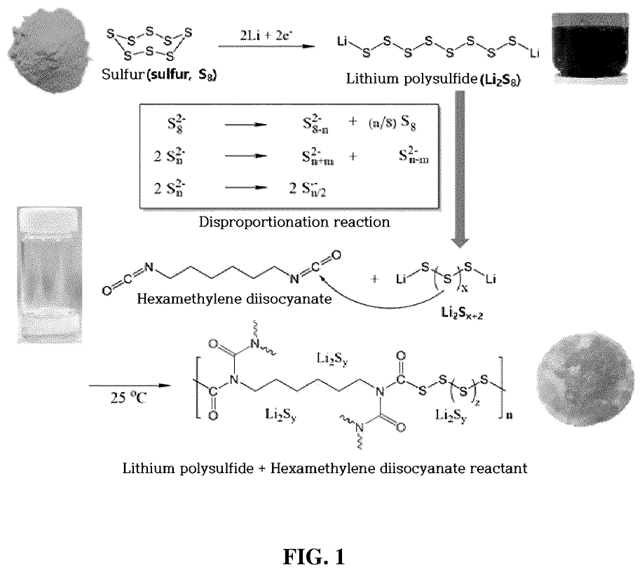

FIG. 1 is a diagram schematically illustrating the mechanism by which lithium polysulfide produced at a cathode reacts with an electrolyte additive including an isocyanate group. In FIG. 1, the electrolyte additive is explained using hexamethylene diisocyanate, but an embodiment of the present disclosure is not limited thereto.

Referring to FIG. 1, in the process of discharging a lithium-sulfur battery, a S₈ sulfur of an annular structure in a cathode is converted into lithium polysulfide of a linear structure (Li₂Sₓ, x=2, 4, 6, 8) as a S—S bond is broken, and lithium polysulfide reacts with hexamethylene diisocyanate to form a polymer membrane as shown in Formula 2.

The electrolyte additive according to an embodiment of the present disclosure reacts with lithium polysulfide eluted into the electrolyte during the discharge process and removes the same from the electrolyte, thereby preventing the electrochemical characteristics of the secondary battery from deteriorating. Simultaneously, the polymer membrane formed by the reaction of the electrolyte additive and lithium polysulfide may, for example, be provided as a conductive polymer layer coated on the surface of a cathode, thereby preventing lithium polysulfide from eluting from the cathode into the electrolyte. Therefore, cycle characteristics may be improved.

Hereinafter, example and comparative example of the present disclosure will be described. The following example is only an embodiment of the present disclosure and the present disclosure is not limited to the following embodiment.

1. Reaction of Lithium Polysulfide with Electrolyte Additive

A lithium polysulfide (Li₂S₈) solution was prepared with reference to Literature (J. Electrochem. Soc, 160, A1205, 2013). Sulfur and lithium were added at a molar ratio of 80/20 to an organic solvent mixed with 1,3-dimethoxyethane (DME) and 1,2-dioxolane (DOL) at a volume ratio of 50/50 and stirred at 60° C. for 72 hours to synthesize lithium polysulfide. The prepared lithium polysulfide was diluted with a solution in which the DME and the DOL were mixed at a volume ratio of 50/50 to prepare a 10% by weight of the lithium polysulfide solution.

Hexamethylene diisocyanate (HDI) in an organic solvent mixed with 1,3-dimethoxyethane (DME) and 1,2-dioxolane (DOL) in a volume ratio of 50/50 was added at 0 wt %, 1 wt %, 3 wt %, and 5 wt %, respectively, as shown in Table 1 below, and then stirred at room temperature to prepare a precursor solution. Experimental Examples 1-1 to 1-4 were prepared by adding 0.5 mL of a lithium polysulfide solution to 5 mL of the precursor solution prepared in an argon atmosphere and stirring the same for 10 minutes at room temperature.

Tetraethylene glycol diacrylate (TEGDA) in an organic solvent mixed with 1,3-dimethoxyethane (DME) and 1,2-dioxolane (DOL) in a volume ratio of 50/50 was added at 10 wt %, 20 wt %, and 30 wt %, respectively, as shown in Table 1 below, and then stirred for 6 hours at room temperature to prepare a precursor solution. The precursor solution was prepared by adding 1% by weight of 2,2-azobisisobutyronitrile (AIBN) as a polymerization initiator based on the tetraethylene glycol diacrylate content. The precursor solution prepared under an argon atmosphere was added to the lithium polysulfide solution and then heat-crosslinked at 80° C. for 2 hours to proceed with radical polymerization, and Experimental Examples 1-5 to 1-7 were prepared.

Each of 1,8-diisocyanatooctane and 2,4,4-trimethylhexamethylene diisocyanate in an organic solvent mixed with 1,3-dimethoxyethane (DME) and 1,2-dioxolane (DOL) in a volume ratio of 50/50 was added at 3 wt % as shown in Table 1 below, and then stirred at room temperature to prepare a precursor solution. Experimental Examples 1-1 to 1-4 were prepared by adding 0.5 mL of a lithium polysulfide solution to 5 mL of the precursor solution prepared in an argon atmosphere and stirring the same for 10 minutes at room temperature.

TABLE 1

| | | | | | Stirring | Stirring |
|---|---|---|---|---|---|---|
| Classification | Precursor solution | | | Initiator | temperature | time |
| Experimental | DME | DOL | HDI- | — | Room | 10 |
| Example | | | 0 wt % | | temperature | minutes |
| 1-1 | | | | | | |
| Experimental | DME | DOL | HDI- | — | Room | 10 |
| Example | | | 1 wt % | | temperature | minutes |
| 1-2 | | | | | | |
| Experimental | DME | DOL | HDI- | — | Room | 10 |
| Example | | | 3 wt % | | temperature | minutes |
| 1-3 | | | | | | |
| Experimental | DME | DOL | HDI- | — | Room | 10 |
| Example | | | 5 wt % | | temperature | minutes |
| 1-4 | | | | | | |
| Experimental | DME | DOL | TEGDA- | AIBN | 80° C. | 2 hours |
| Example | | | 10 wt % | | | |
| 1-5 | | | | | | |
| Experimental | DME | DOL | TEGDA- | AIBN | 80° C. | 2 hours |
| Example | | | 20 wt % | | | |
| 1-6 | | | | | | |
| Experimental | DME | DOL | TEGDA- | AIBN | 80° C. | 2 hours |
| Example | | | 30 wt % | | | |
| 1-7 | | | | | | |
| Experimental | DME | DOL | DIO- | — | Room | 10 |
| Example | | | 3 wt % | | temperature | minutes |
| 1-8 | | | | | | |
| Experimental | DME | DOL | TMHMD- | — | Room | 10 |
| Example | | | 3 wt % | | temperature | minutes |
| 1-9 | | | | | | |

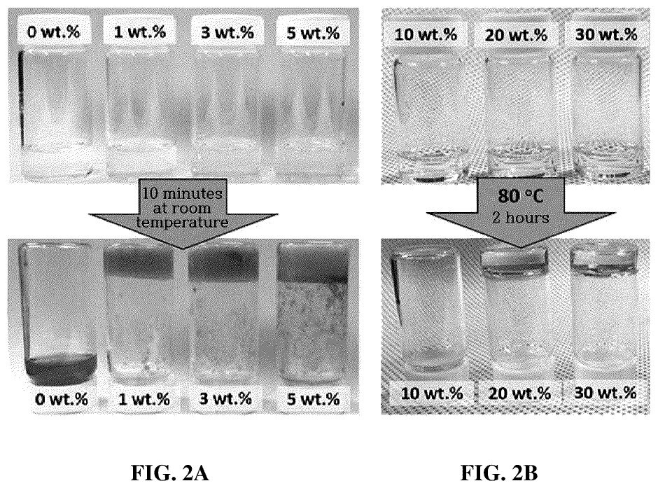

FIGS. 2A and 2B show the results of identifying the reactivity with lithium polysulfide according to the type of precursor solution according to Experimental Examples 1-1 to 1-7. FIGS. 2A and 2B show the results of identifying the difference in reactivity of each electrolyte additive material, and shows each of (a) lithium polysulfide and hexamethylene diisocyanate, and (b) 2,2-azobisisobutyronitrile and tetraethylene glycol diacrylate.

Referring to Table 1 and FIGS. 2A and B, it was identified that no precipitate was formed when hexamethylene diisocyanate was not added, whereas when 1 wt % of hexamethylene diisocyanate was added, a yellowish solid was produced. In other words, when hexamethylene diisocyanate was added, it was identified that hexamethylene diisocyanate and lithium polysulfide polymerized to form a polymer at room temperature without adding a separate polymerization initiator.

It was identified that when tetraethylene glycol diacrylate was added, a polymer network strong enough to limit the fluidity of the organic solvent was not produced when 10 wt % thereof was added. In addition, it was identified that tetraethylene glycol diacrylate requires a polymerization initiator, the reaction proceeds at a high temperature, the reaction time is longer than that of hexamethylene diisocyanate, and a larger amount thereof needs to be added to carry out the reaction.

In other words, it was identified that hexamethylene diisocyanate had high reactivity with polysulfide and was able to be used as a reactive additive to suppress the dissolution and migration of lithium polysulfide in lithium-sulfur batteries.

In comparison of Experimental Example 1-3 in which 3 wt % of hexamethylene diisocyanate was added with Experimental Examples 1-8 and 1-9 in which 1,8-diisocyanatooctane and 2,4,4-trimethylhexamethylene diisocyanate were added, respectively, it was identified that Experimental Examples 1-8 and 1-9 also reacted within 10 minutes at room temperature to form polymers, similar to Experimental Example 1-3. It was identified that 1,8-diisocyanatooctane was composed of a long chain with more carbon atoms than hexamethylene diisocyanate, and that although 2,4,4-trimethylhexamethylene diisocyanate was a cross-linked form (branched chain) with the same chain length as hexamethylene diisocyanate, 1,8-diisocyanatooctane and 2,4,4-trimethylhexamethylene diisocyanate both included an isocyanate functional group (—N═C═O) and exhibited a similar tendency to hexamethylene diisocyanate.

### 2. Suppression of Lithium Polysulfide Elution Through Addition of Electrolyte Additive

A lithium polysulfide (Li₂S₈) solution was prepared with reference to Literature (J. Electrochem. Soc, 160, A1205, 2013). Sulfur and lithium were added at a molar ratio of 80/20 to an organic solvent mixed with 1,3-dimethoxyethane (DME) and 1,2-dioxolane (DOL) at a volume ratio of 50/50 and stirred at 60° C. for 72 hours to synthesize lithium polysulfide. The prepared lithium polysulfide was diluted with a solution in which the DME and the DOL were mixed at a volume ratio of 50/50 to prepare a 10% by weight of the lithium polysulfide solution.

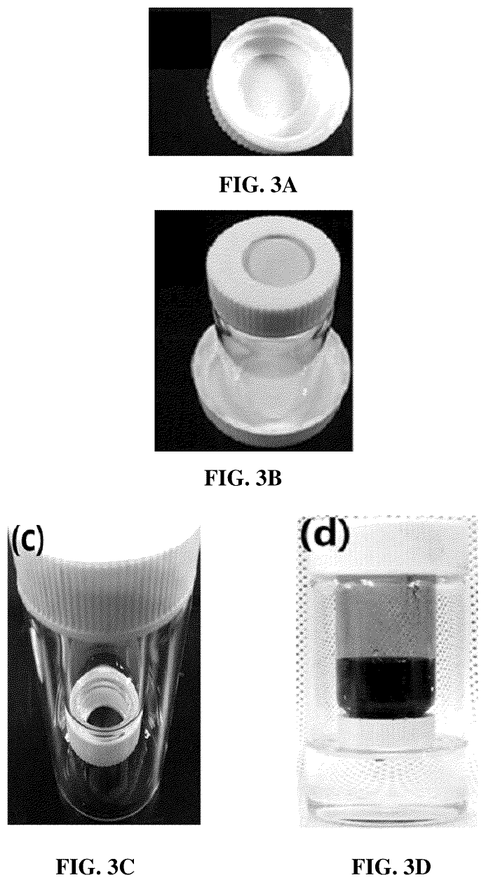

An organic solvent mixed with 1,3-dimethoxyethane (DME) and 1,2-dioxolane (DOL) at a volume ratio of 50/50, an organic solvent in which 1,3-dimethoxyethane (DME) and 1,2-dioxolane (DOL) were mixed at a volume ratio of 50/50 and then 3 wt % of hexamethylene diisocyanate was added to hexamethylene diisocyanate (HDI), an organic solvent composed only of hexamethylene diisocyanate, an organic solvent to which 3 wt % of 1,8-diisocyanatooctane was added, and an organic solvent to which 3 wt % of 2,4,4-trimethylhexamethylene diisocyanate was added were each prepared as shown in Table 2. After adding the prepared solution (transparent color) to a lower portion of the external reactor formed as shown in FIG. 3C, a lithium polysulfide solution (brown) was injected into the internal reactor for preparation as shown in FIG. 3D.

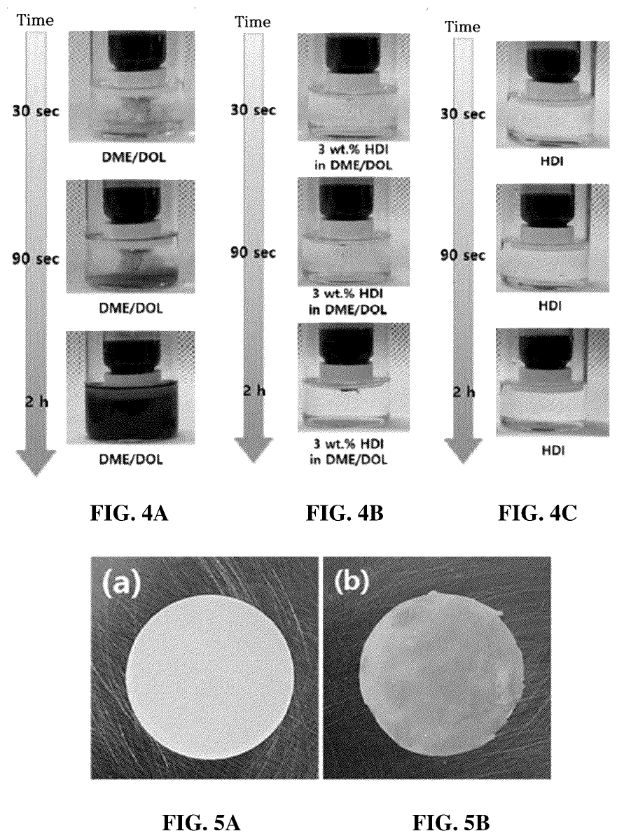

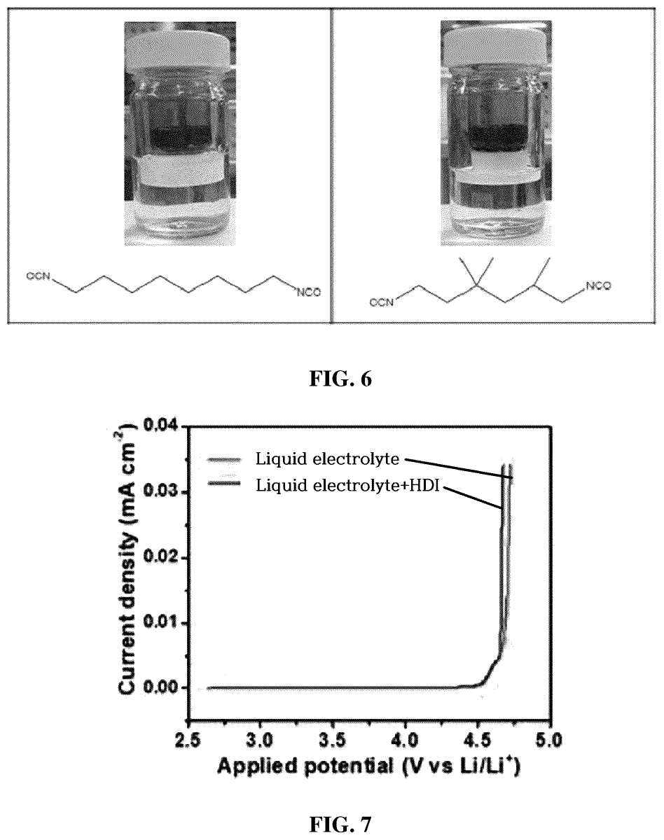

FIGS. 3A, 3B, 3C and 3D are a reaction device for identifying suppression of lithium polysulfide elution. The reaction device is composed of an external reactor, which is a large-sized vial, and a small-sized vial, which is an internal reactor mounted inside the external reactor. As shown in FIG. 3A, the internal reactor has a hole formed at a lower end, and the hole was blocked with a polyethylene (PE) film separator (Asahi-Kasei ND420 product, thickness: 20 mm, porosity: 40%) manufactured using a wet method. One side of the internal reactor was mounted and secured to an upper cap of the external reactor. After preparation as shown in FIGS. 3A, 3B, 3C and 3D, the effect of hexamethylene diisocyanate was identified by changing the time to 30 seconds, 90 seconds, and 2 hours, and this is illustrated in FIGS. 4A, 4B and 4C. In addition, after using Experimental Examples 2-4 and 2-5 and maintaining the time for 10 minutes, the effects of 1,8-diisocyanatooctane and 2,4,4-trimethylhexamethylene diisocyanate were identified. FIGS. 4A, 4B and 4C show the results of identifying the extent to which the elution of lithium polysulfide is suppressed by hexamethylene diisocyanate. FIGS. 5A and 5B are a diagram illustrating each of (a) a polyethylene (PE) separator (Asahi-Kasei ND420 product, thickness: 20 mm, porosity: 40%) and (b) the product of Experimental Example 2-2 formed on the polyethylene separator (b). FIG. 6 shows the results of identifying the extent to which the elution of lithium polysulfide is suppressed by 1,8-diisocyanatooctane and 2,4,4-trimethylhexamethylene diisocyanate.

TABLE 2

| Classification | DME | DOL | HDI | DIO | TMHMD |
|---|---|---|---|---|---|
| Experimental Example 2-1 | 50 v/v | 50 v/v | 0 wt % | — | — |
| Experimental Example 2-2 | 50 v/v | 50 v/v | 3 wt % | — | — |
| Experimental Example 2-3 | 0 | 0 | 100 wt % | — | — |
| Experimental Example 2-4 | 50 v/v | 50 v/v | — | 3 wt % | — |
| Experimental Example 2-5 | 50 v/v | 50 v/v | — | — | 3 wt % |

Referring to Table 2 and FIGS. 3A to 5B, it was identified that when hexamethylene diisocyanate was not added as in Experimental Example 2-1, a large amount of lithium polysulfide diffused from an internal vial to an external vial. On the other hand, it was identified that when 3 and 100% by weight of hexamethylene diisocyanate were applied, lithium polysulfide did not elute and was maintained in the internal vial. This identifies that the diffusion of lithium polysulfide is effectively blocked because a macromolecular polymer is formed at the interface in Experimental Example 2-2 due to a chemical reaction between lithium polysulfide and hexamethylene diisocyanate. Referring to FIGS. 5A and 5B, (a) is a polyethylene film in which the polymer of Experimental Example 2-1 was not formed, and (b) is a polyethylene film in which the polymer of Experimental Example 2-2 was formed. In comparison with Experimental Example 2-1, it was identified that in the case of Experimental Example 2-2, the polymer formed by lithium polysulfide and hexamethylene diisocyanate was not dissolved in the mixed solvent provided at a lower portion of the external vial, but was formed at the interface. In other words, it was identified that when a mixed solution prepared by adding 3 wt % of hexamethylene diisocyanate was used, a yellow, strong macromolecular polymer was formed in layers at the interface in contact with lithium polysulfide, and the produced macromolecular polymer had the function of blocking the migration of lithium polysulfide.

FIG. 6 is a photograph after maintaining each for 10 minutes in Experimental Examples 2-4 and 2-5, and it was identified that the results were similar to Experimental Example 2-2. In other words, it was identified that even when 1,8-diisocyanatooctane and 2,4,4-trimethylhexamethylene diisocyanate were applied, it exhibited the same effect as hexamethylene diisocyanate, which is because the diisocyanate included in 1,8-diisocyanatooctane and 2,4,4-trimethylhexamethylene diisocyanate reacted with lithium polysulfide to form a polymer membrane at the interface, which suppressed the elution of polysulfide.

3. Electrochemical Characteristics of Liquid Electrolyte Added with Macromolecular Polymer and Electrolyte Additive

Lithium bis(trifluoromethanesulfonyl)imide at a concentration of 1.0 M was dissolved in a solution mixed with 1,3-dimethoxyethane (DME) and 1,2-dioxolane (DOL) at a volume ratio of 50/50. Liquid electrolyte was prepared by adding lithium nitrate (LiNO₃) as an additive at a concentration of 0.4 M.

A commercial separator manufactured by stretching a polyethylene (PE) film, the polyethylene film used in Experimental Example 2-2 (see FIG. 5B), the polyethylene film used in Experimental Example 2-4, and the polyethylene film used in Experimental Example 2-5 were each impregnated in the liquid electrolyte prepared previously, and then the ionic conductivity was measured at 25° C. The results are shown as Experimental Examples 3-1 to 3-4 in Table 3. In the case of Experimental Examples 3-2 to 3-4, a polymer layer is formed by each of hexamethylene diisocyanate, 1,8-diisocyanatooctane, and 2,4,4-trimethylhexamethylene diisocyanate on the polyethylene separator, demonstrating the properties of the physical gel impregnated with the liquid electrolyte.

TABLE 3

| | | Ionic |
|---|---|---|
| | | conductivity |
| Classification | Material | (S/cm) |
| Experimental Example 3-1 | PE | 5.6 × 10⁻⁴ |
| Experimental Example 3-2 | PE_HDI polymer layer | 4.8 × 10⁻⁴ |
| Experimental Example 3-3 | PE_DIO polymer layer | 2.3 × 10⁻⁴ |
| Experimental Example 3-4 | PE_TMHMD polymer layer | 1.1 × 10⁻⁴ |

Referring to Table 3, upon comparing the ionic conductivity of PE, which is generally used as a separator in lithium-sulfur batteries, and the cases where polymers are formed on the same PE by lithium polysulfide, hexamethylene diisocyanate, 1,8-diisocyanatooctane, and 2,4,4-trimethylhexamethylene diisocyanate, it was identified that both sides showed similar values. In other words, when the electrolyte additive according to an embodiment of the present disclosure was used in a lithium-sulfur battery, it was shown that similar ionic conductivity performance was able to be maintained even when the electrolyte additive reacted with lithium polysulfide to form a polymer. In other words, it was identified that the polymer formed by reacting the electrolyte additive with lithium polysulfide was an ion-conductive polymer, preventing lithium polysulfide from being released from the cathode into the electrolyte and simultaneously having no effect on the migration of ions.

The electrochemical stability of the prepared liquid electrolyte and the case where 3 wt % of hexamethylene diisocyanate was added to the liquid electrolyte and stirred at room temperature was evaluated by linear-sweep voltammetry. FIG. 7 shows the results identified according to the linear-sweep voltammetry in the case of liquid electrolyte and in the case of adding hexamethylene diisocyanate (HDI) to the liquid electrolyte.

Referring to FIG. 7, when hexamethylene diisocyanate (HDI) was added to the liquid electrolyte, no peak due to additional decomposition occurred in the voltage range of 4.5 V or below, and the oxidation stability of 4.5 V vs Li/+, equivalent to the case composed only of the liquid electrolyte, was shown. In other words, even when hexamethylene diisocyanate was added to the liquid electrolyte, it was identified that the battery was stably driven within the operating voltage range of 1.6 to 2.7 V, which is the operating voltage range of a lithium-sulfur battery.

### 4. Cell Characteristics and Cathode Surface Evaluation of Lithium-Sulfur Batteries

Sulfur and lithium were added at a molar ratio of 80/20 to an organic solvent mixed with 1,3-dimethoxyethane (DME) and 1,2-dioxolane (DOL) at a volume ratio of 50/50 and stirred at 60° C. for 72 hours to synthesize lithium polysulfide. The lithium polysulfide was diluted with a solution in which the DME and the DOL were mixed at a volume ratio of 50/50 to prepare a 10% by weight of the lithium polysulfide solution.

A slurry was prepared by adding the conductive materials of carbon black, Super-P, and polyvinylidene fluoride binder to N-methyl-2-pyrrolidone (NMP) at a weight ratio of 30:30:20. The slurry was applied to an aluminum (Al) thin film, which is a cathode current collector, and vacuum dried at 80° C. for 12 hours to prepare a carbon electrode.

The sulfur cathode (5.6 mAh/cm²) was prepared by impregnating a lithium polysulfide solution on a carbon electrode prepared under an argon atmosphere and then vacuum drying the same at 60° C. for 12 hours.

Lithium bis(trifluoromethanesulfonyl)imide at a concentration of 1.0 M was dissolved in a solution mixed with 1,3-dimethoxyethane (DME) and 1,2-dioxolane (DOL) at a volume ratio of 50/50. Liquid electrolyte was prepared by adding lithium nitrate (LiNO₃) as an additive at a concentration of 0.4 M.

Each of 1 wt %, 3 wt %, and 5 wt % of hexamethylene diisocyanate (HDI) was added to the prepared liquid electrolyte and stirred at room temperature to prepare a liquid electrolyte to which hexamethylene diisocyanate was added.

Li metal was used as an anode active material. A cell was prepared by sequentially stacking the prepared cathode, polyethylene separator, and anode. The lithium-sulfur batteries of Experimental Examples 4-1, 4-2, and 4-3 were manufactured by injecting liquid electrolytes added with each of 1 wt %, 3 wt %, and 5 wt % of hexamethylene diisocyanate, and the lithium-sulfur battery of Experimental Example 4-4 was manufactured by injecting only pure liquid electrolyte without hexamethylene diisocyanate added.

TABLE 4

| Classification | Additive |
|---|---|
| Experimental Example 4-1 | HDI - 1 wt % |
| Experimental Example 4-2 | HDI - 3 wt % |
| Experimental Example 4-3 | HDI - 5 wt % |
| Experimental Example 4-4 | HDI - 0 wt % |

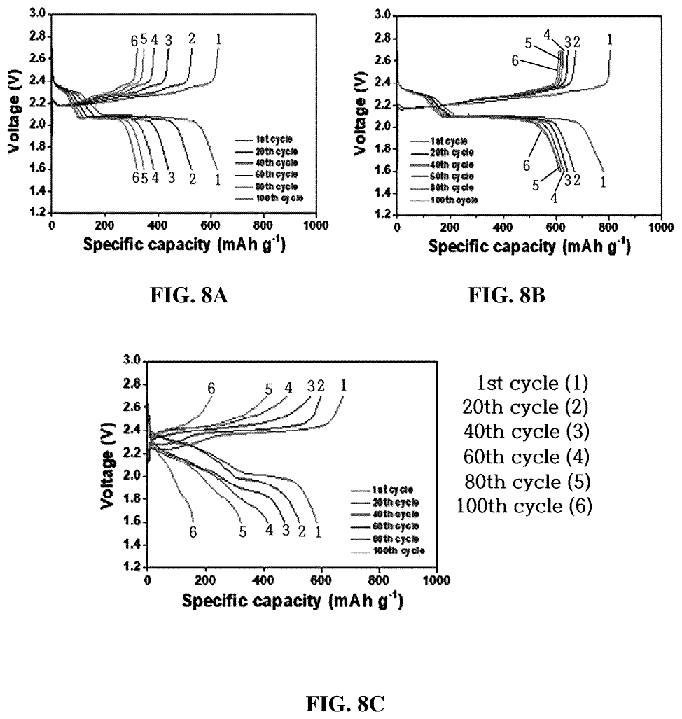

FIGS. 8A, 8B and 8C are a graph showing charge and discharge cycles according to hexamethylene diisocyanate content. In FIGS. 8A, 8B and 8C, (a) contains 1 wt %, (b) contains 3 wt %, and (c) contains 5 wt %, which are each different amount of hexamethylene diisocyanate.

The activation (formation) process was performed at a current density of 0.2 mA/cm² in the voltage range of 1.6 to 2.7 V at room temperature, and then a charge/discharge experiment was performed at a current density of 0.5 mA/cm². Referring to FIG. 7, it was shown that the lithium-sulfur battery applying a liquid electrolyte of a composition of 3 wt % of hexamethylene diisocyanate had the highest discharge capacity and excellent capacity retention rate. It was identified that when 1 wt % of hexamethylene diisocyanate was applied, the elution of lithium polysulfide was not sufficiently suppressed due to the low content of hexamethylene diisocyanate, and that when 5 wt % thereof was applied, excessive hexamethylene diisocyanate reacted with lithium polysulfide; accordingly, capacity was shown to be low due to insufficient lithium polysulfide needed to drive the cell. In other words, it was identified that the lithium-sulfur battery applying a composition in which 3 wt % of hexamethylene diisocyanate was added to the liquid electrolyte exhibited the best battery characteristics.

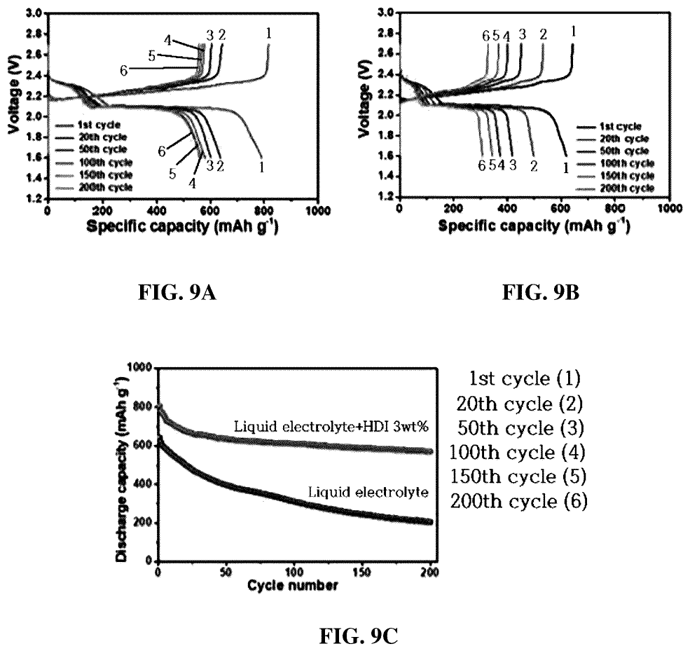

FIGS. 9A, 9B and 9C show the results of identifying charge/discharge curves and lifespan characteristics depending on whether 3 wt % of hexamethylene diisocyanate is included in the electrolyte. In FIGS. 9A, 9B and 9C, (a) is the case including 3 wt % of hexamethylene diisocyanate, and (b) is the case not including the same.

In FIGS. 9A, 9B and 9C, the activation (formation) process was performed on the lithium-sulfur battery at a current density of 0.2 mA/cm² in the voltage range of 1.6 to 2.7 V at room temperature, and then a charge/discharge experiment was performed at a current density of 0.5 mA/cm². It was identified that Experimental Example 4-2 exhibited improved initial discharge capacity and stable capacity maintenance compared to Experimental Example 4-4. When hexamethylene diisocyanate is included as in Experimental Example 4-2, it chemically reacts with the lithium polysulfide produced in the cathode to form a polymer layer and blocks the dissolution and migration of lithium polysulfide, thereby improving the charge and discharge characteristics of the battery. In other words, this implies that the cycle performance of a lithium-sulfur battery may be improved when a small amount of hexamethylene diisocyanate is applied to the liquid electrolyte.

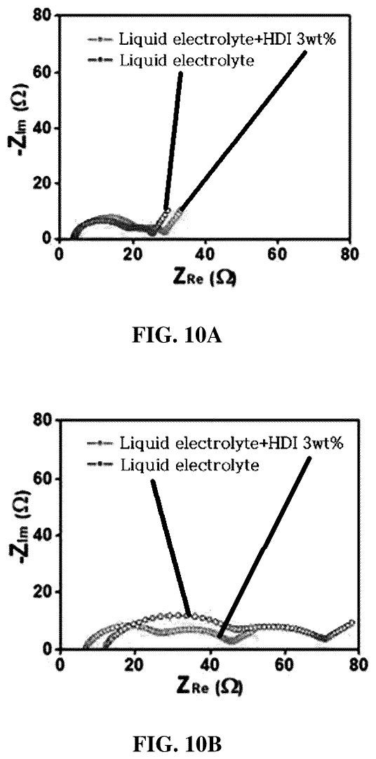

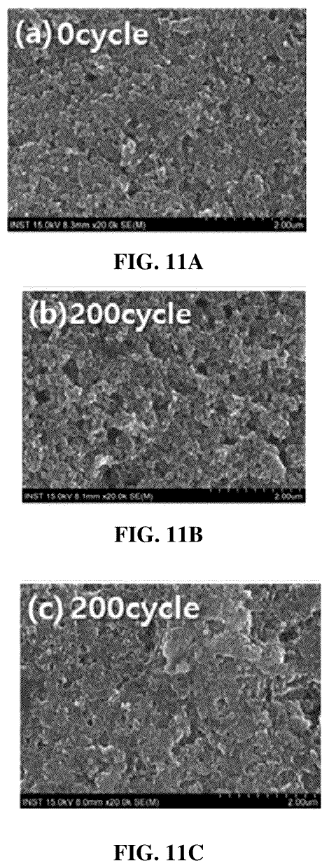

FIGS. 10A and 10B show the results of impedance interfacial resistance analysis (a) before cycling and (b) after 200 cycles depending on whether 3 wt % of hexamethylene diisocyanate is included in the electrolyte. FIGS. 11A, 11B, and 11C are SEM photographs of the cathode surface before cycling and after 200 cycles. In FIGS. 11A-11C, (a) is an electron micrograph of the cathode surface before performing a charge/discharge cycle, (b) is an electron micrograph of the cathode surface obtained after 200 cycles in the case where 3 wt % of hexamethylene diisocyanate is not included, and (c) is an electron micrograph of the cathode surface obtained after 200 cycles in the case where 3 wt % of hexamethylene diisocyanate is included.

Referring to FIG. 10A, before cycling, the lithium-sulfur battery of Experimental Example 4-2 (including 3 wt % of hexamethylene diisocyanate) and the lithium-sulfur battery of Experimental Example 4-4 (not including 3 wt % of hexamethylene diisocyanate) exhibited similar electrolyte resistances. Experimental Example 4-2 appears to show a slightly larger value, and this difference is determined to be due to a slight increase in interfacial resistance due to the polymer layer formed by the reaction of hexamethylene diisocyanate in the process of activation.

Referring to FIG. 10B, it was identified that after 200 cycles, Experimental Example 4-2 had lower electrolyte resistance and interfacial resistance than Experimental Example 4-4. This is because in Experimental Example 4-4, lithium polysulfide eluted into the liquid electrolyte during cycling causes an increase in electrolyte viscosity, thereby increasing electrolyte resistance and interfacial resistance. On the other hand, in Experimental Example 4-2, it was identified that there was little increase in electrolyte resistance and interfacial resistance even after the cycle was performed compared to Experimental Example 4-4, which is determined to be because lithium polysulfide did not elute into the electrolyte.

FIGS. 11A, 11B and 11C show the results of analyzing the cathode surface through SEM after analyzing the charge and discharge lifespan characteristics before cycling and after 200 cycles in a lithium-sulfur battery using each electrolyte. Compared to the cathode before cycling in (a), the cathode of Experimental Example 4-4 after 200 cycles was identified to have a porous structure due to the heterogeneous electrochemical reaction of lithium polysulfide and dissolution of lithium polysulfide (FIG. 11B). On the other hand, it was identified that the cathode of Experimental Example 4-2 was covered with a dense polymer layer after 200 cycles (FIG. 11C). In other words, it was determined that hexamethylene diisocyanate added in a small amount may suppress lithium polysulfide dissolution and migration, thereby providing stable internal resistance and improved cycle characteristics of the battery.

In an embodiment of the present disclosure, by including a small amount of an additive including a highly reactive isocyanate functional group as an additive in a liquid electrolyte, an ion-conductive polymer layer is formed through a chemical reaction with lithium polysulfide, thereby suppressing the elution of lithium polysulfide generated from a cathode. Accordingly, the lithium-sulfur battery to which an electrolyte containing a small amount of the hexamethylene diisocyanate additive is applied suppresses the decline in the capacity of the cathode due to lithium polysulfide elution, thereby enabling the implementation of a high-capacity battery and the stable application of sulfur with high energy density. Furthermore, the lithium-sulfur battery with improved battery lifespan characteristics while maintaining low manufacturing costs can be provided.

It will be appreciated that the technical configuration of the present disclosure as described above may be practiced by those skilled in the art to which the present disclosure pertains in other specific forms without departing from the technical spirit or essential characteristics of the present disclosure. It is, therefore, to be understood that the embodiments as described above are to be considered in all respects only as illustrative and not restrictive. The scope of the present disclosure is defined by the appended claims rather than the above detailed description. All changes or modifications that come within the meaning and range of equivalency of the claims, and equivalents thereof, are to be construed as being included within the scope of the present disclosure.

1. An electrolyte for a lithium-sulfur battery comprising: a base electrolyte comprising a lithium salt and an organic solvent; and an electrolyte additive, wherein the electrolyte additive comprises an isocyanate functional group (—N═C═O).

2. The electrolyte of claim 1, wherein the electrolyte additive comprises one or more of hexamethylene diisocyanate, isophorone diisocyanate, methylene diisocyanate, toluene diisocyanate, 4,4-diisocyanato dicyclohexylmethane, 1,5-naphthalene diisocyanate, tetramethyl xylene diisocyanate, para-phenylene diisocyanate, 1,4-cyclohexane diisocyanate, 1,8-diisocyanatooctane, or 2,4,4-trimethylhexamethylene diisocyanate.

3. The electrolyte of claim 1, wherein the lithium salt comprises at least one of LiPF₆, LiBF₄, LiClO₄, LiSbF₆, LiAsF₆, Li(NO₃)₃, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LISCN, LiAlO₂, LiAl Cl₄, LiN(CₓF₂ₓ₊₁SO₂)(C_{y}F_{2y+1}SO₂), where x and y are natural numbers, LiCl, LiI, or LiB(C₂O₄)₂.

4. The electrolyte of claim 1, wherein the lithium salt is included at a molar concentration of 0.1 M to 5 M.

5. The electrolyte of claim 1, wherein:
the organic solvent is a non-aqueous organic solvent; and
the non-aqueous organic solvent comprises at least one of an ether-based material, 1,2-dimethoxyethane, 1,3-dioxolane, or dimethyl sulfoxide.

6. The electrolyte of claim 5, wherein the ether-based material comprises at least one of diethylene glycol dimethyl ether, triethylene glycol dimethyl ether, or tetraethylene glycol dimethyl ether.

7. The electrolyte of claim 1, wherein the electrolyte additive is included in an amount of 1 to 5 parts by weight based on 100 parts by weight of the electrolyte for the lithium-sulfur battery.

8. A lithium-sulfur battery comprising:
the electrolyte for the lithium-sulfur battery according to claim 1;
a cathode comprising a sulfur compound;
an anode comprising lithium; and
a separator interposed between the cathode and the anode.

9. The lithium-sulfur battery of claim 8, wherein at least one of the cathode or the separator further comprises a polymer layer represented by Formula 1 below: 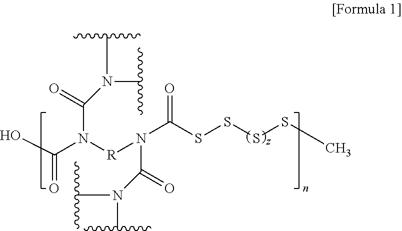
wherein, R is a substituted or unsubstituted C1 to C30 alkyl group or a substituted or unsubstituted C1 to C30 haloalkyl group, n is an integer from 1 to 100, and z is an integer from 1 to 5.

10. The lithium-sulfur battery of claim 9, wherein:
the Formula 1 is formed by reacting lithium polysulfide with an electrolyte additive; and
the electrolyte additive comprises an isocyanate functional group (—N═C═O).

11. The lithium-sulfur battery of claim 10, wherein the electrolyte additive comprises one or more of hexamethylene diisocyanate, isophorone diisocyanate, methylene diisocyanate, toluene diisocyanate, 4,4-diisocyanato dicyclohexylmethane, 1,5-naphthalene diisocyanate, tetramethyl xylene diisocyanate, para-phenylene diisocyanate, 1,4-cyclohexane diisocyanate, 1,8-diisocyanatooctane, or 2,4,4-trimethylhexamethylene diisocyanate.

12. The lithium-sulfur battery of claim 11, wherein:
the electrolyte additive comprises one or more of hexamethylene diisocyanate, 1,8-diisocyanatooctane, or 2,4,4-trimethylhexamethylene diisocyanate; and
the electrolyte additive reacts with lithium polysulfide to produce one or more of Formulas 2, 3, or 4 below, and is provided in at least one of the cathode or the separator: 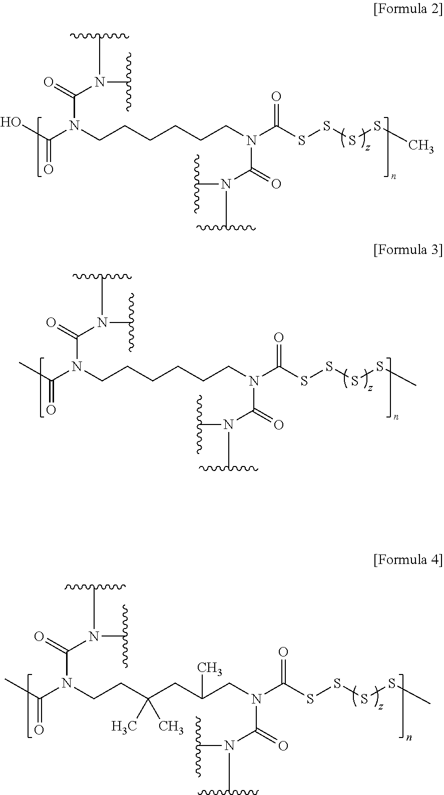
wherein, n is an integer from 1 to 100, and z is an integer from 1 to 5.
